(19) United States
(12) Patent Application Publication
(10) Pub. No.: US 2009/0043864 A1
(43) Pub. Date: Feb. 12, 2009

(54) Method and System for Generating Globally Unique Identifiers

(76) Inventor: Rohit Shetty, Bangalore (IN)

Correspondence Address: IBM CORPORATION;INTELLECTUAL PROPERTY LAW, 11501 BURNET ROAD, AUSTIN, TX, 78758, US

(21) Appl. No.: 11/834,976

(22) Filed: Aug. 7, 2007

(51) Int. Cl. G06F 15/16; G06F 17/30; G06F 7/10

(52) U.S. Cl. 709/217; 707/102; 707/2; 707/E17.008; 707/E17.01

(57) ABSTRACT

There is disclosed a system for assigning a GUID to a resultant entity generated by converting a source entity, in a GUID assignment system having a processing means and a storage device. Information about the source entity corresponding to the resultant entity and the origin of the source entity into is inputted into the processing means from the storage device. The processing means generates an origin unique ID using the information about the origin of the source entity, and a source entity unique ID using the information about the source entity. The processing means then concatenates the origin unique ID and the entity unique ID and calculates the hash of said concatenation result to generate a GUID and tags the generated GUID to the resultant entity.

### FIELD OF THE INVENTION

The present invention relates to a method, system, and a computer program product for generating a globally unique identifier, in particular generating a globally unique identifier for data conversion.

### BACKGROUND

Globally Unique Identifiers (GUIDs) are assigned to data so that the data can be identified globally, and uniquely. With the use of GUIDs, it becomes possible to store, retrieve or trace data in a data processing system. GUIDs are useful especially when system components are connected via a network or when several systems communicate over the Internet.

Data conversion is an important activity in data management, especially in circumstances where several systems share the use of data or when data generated by different systems are used on a common platform. Data conversion is performed, for example, to convert logs to a standard format, or when migrating data processing systems.

A number of disadvantages arise when a GUID is to be assigned to target data obtained by conversion. One factor to consider is that it is desirable to be able to trace the target data (hereinafter called “resultant entity”) back to the data which was converted (hereinafter called “source entity”). Even if not, it is preferable for the GUID of the resultant entity to be otherwise related to the source entity. It is also preferable if the reproducibility of the GUID assignment process can be ensured, so that the same GUID would be assigned to the resultant entity if the source entity was converted by the same conversion process, or the source entity was originally found in the same context.

The following description uses the example of log/audit records as the source/resultant entities, but the same concept may be applied to other areas or domains involving data conversion, such as conversion of source code to compiled output, image format conversion (BMP to JPEG etc), data migration (as in databases, from one database schema to another), conversion between file formats (OS file formats, FAT 32 to NTFS), conversion between audio and video formats (Audio to MP3, MOV to MPEG etc), conversion between audio to text or vice versa, conversion between data formats (one XML format to another or one proprietary format to another).

The source entity may either have a unique identifier based on the existing GUID algorithms or have no identifiers which help identify the source entity globally. Common Base Event records are typical examples of records with GUIDs. There are other kinds of log records that are not tagged with GUIDs. Both these types of records can be addressed as the source entities in the later description of embodiments.

If a source entity has a GUID and information of the GUID of the source entity is by some means passed onto the resultant entity of the conversion, it would be possible to trace the resultant entity back to the source entity using the information of the GUID of the source entity. However, if a source entity with no GUID is converted into a resultant entity in some other format, then it cannot be determined from the resultant entity what source entity was used to obtain it.

Consider converting a Websphere Application Server (WAS) log to Common Base Events representing events in a different format, where the WAS log has 100 records (source entities). The WAS log is read out, subjected to conversion mapping, and the resultant records (resultant entities) are generated (e.g., Common Base Events), and are assigned GUIDs. Supposing the generated Common Base Events were sent to a receiver apparatus and a need arises to perform the conversion described previously. If the new resultant records are sent to the receiver apparatus with new GUIDs (differing from the previous ones), then the receiver apparatus will consider the new set of resultant records to be different from the previous set of resultant records even if they are same records obtained by converting the same source records using the same conversion process. This occurs because the GUIDs generated during conversion are for the new record created and does not identify the actual source record. A disadvantage is that, if the new set of resultant records cannot be identified with the previous set of resultant records, then it can lead to data redundancy and the waste of the storage resources of the receiver apparatus.

A further disadvantage is related to assigning GUIDs in connection with different conversion processes. The same source record may be processed for conversion under different conditions, causing the resultant records to be unrelated or dissimilar. It would not be appropriate to consider these resultant records as the same record, i.e., one conversion may be from a problem determination perspective and the other from an auditing perspective. The two conversion processes would then typically focus on different contents of the source record and the resultant records cannot be represented by the same unique identifier. Instead, it would be advantageous if the two records have distinct identifiers and whenever the same conversions are run on the record they should generate the same identifiers.

A further disadvantage is related to the order of occurrence of the log records within the context. The same record (same content) might occur multiple times in a particular log, but each of these occurrences should be represented uniquely with distinct identifier which means that where and how a record appears should also be considered while tagging it with a GUID.

The conventional method of assigning unique identifiers to records using existing GUID algorithm does not take into account the scenario of the conversion process or the context of the records. There exists a need to provide a method for assigning GUID to a resultant entity obtained by converting a source record where the assigned GUID reflects the scenario of the conversion process or the context of the source entity.

In simple terms, if the same source entity is converted at different times to some standard format using the same mapping/rules, then there needs to be a means to determine that they are same entities according to the GUID assigned to the resultant entities. It is further preferable that identifiers can be assigned with a high degree of probability of uniqueness, as is the advantage of the GUID.

### SUMMARY

It is an object of this invention to ameliorate one or more of the above mentioned problems.

There is disclosed a method, a system and a computer program product for assigning a GUID to a resultant entity generated by converting a source entity, in a GUID assignment system having a processing means and a storage device. Information about the source entity corresponding to the resultant entity and the origin of the source entity into is inputted into the processing means from the storage device. The processing means generates an origin unique ID using the information about the origin of the source entity, and a source entity unique ID using the information about the source entity. The processing means then concatenates the origin unique ID and the entity unique ID and calculates the hash of said concatenation result to generate a GUID and tags the generated GUID to the resultant entity.

Other aspects of the invention also are disclosed.

### BRIEF DESCRIPTION OF THE DRAWINGS

Embodiments of the present invention will now be described with reference to the drawings, in which:

FIG. 1 shows a schematic block diagram of a computer system on which the present invention can be implemented;

FIG. 2 is a detailed block diagram of the computer module according to the present disclosure;

FIG. 3 is a schematic structure of a source entity database according to the present disclosure;

FIG. 4 is a schematic structure of a resultant entity database according to the present disclosure;

FIG. 5 shows a flowchart of entity conversion and GUID assignment according to the present disclosure;

FIG. 6 shows a flowchart for generating an origin unique ID according to the present disclosure;

FIG. 7 shows a flowchart for generating a source entity unique ID according to the present disclosure;

FIG. 8 shows a flowchart for generating a mapping unique ID according to the present disclosure;

FIG. 9 shows a flowchart for generating a source entity context unique ID according to the present disclosure; and

FIG. 10 shows a flowchart for generating a data conversion GUID according to the present disclosure.

### DETAILED DESCRIPTION

Computer Platform

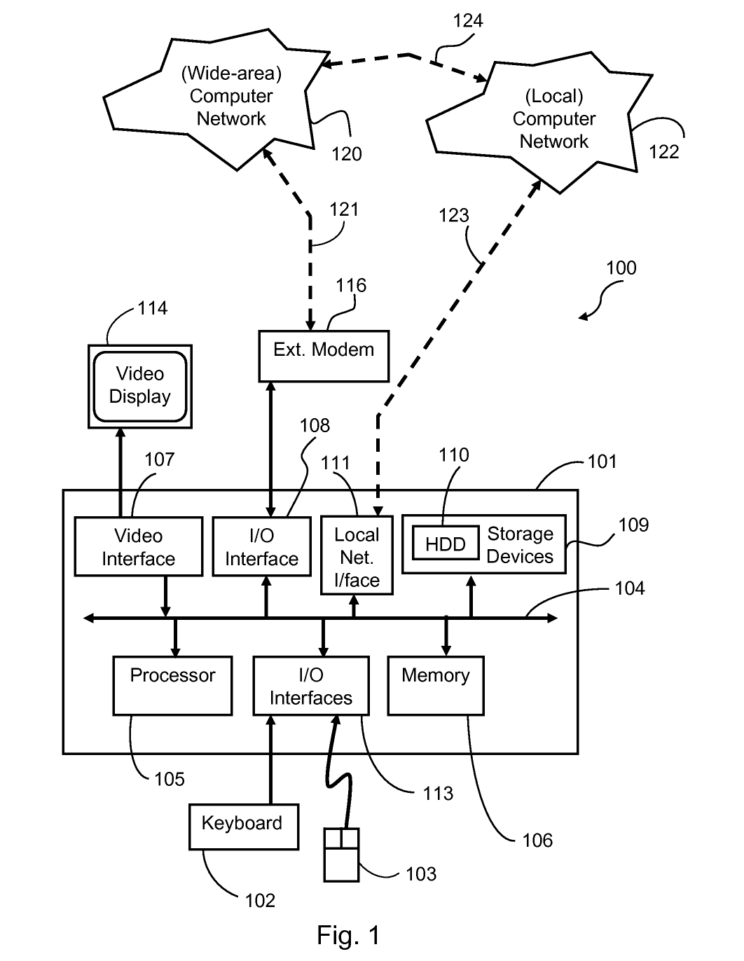

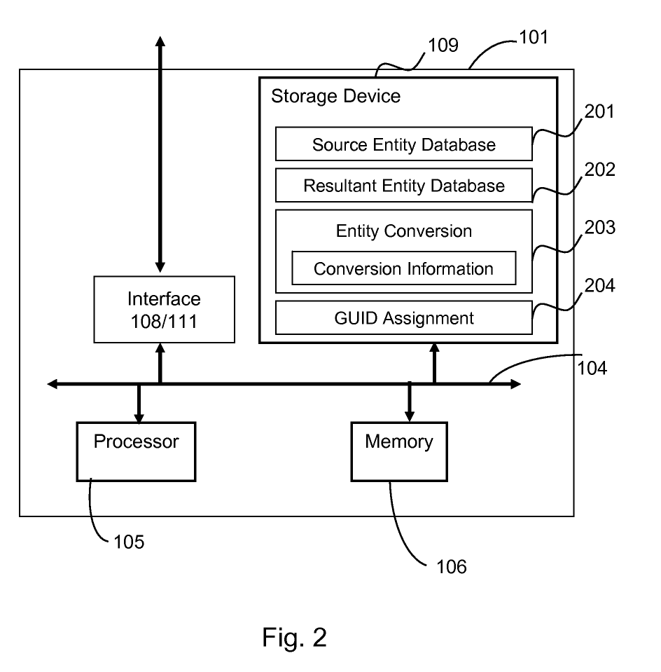

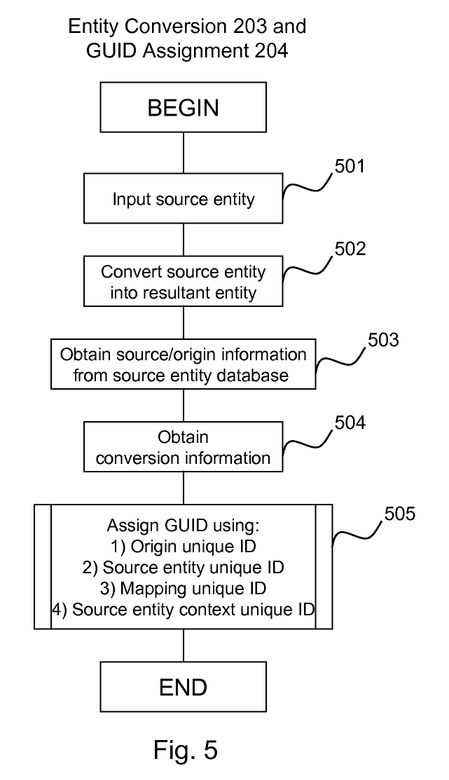

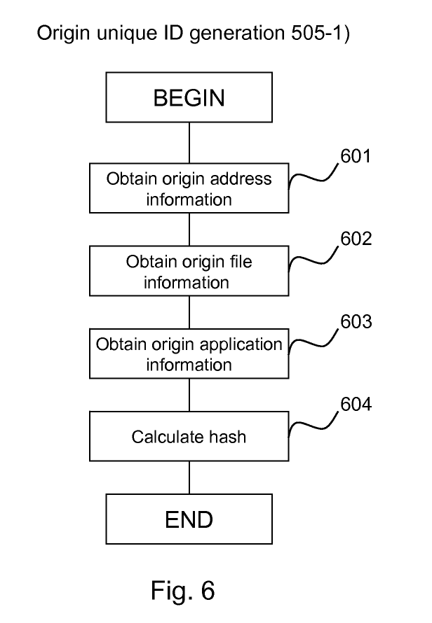

FIG. 1 shows a schematic block diagram of a general purpose computer system with which arrangements describe below using FIGS. 2 to 10 can be implemented. The processes of FIGS. 5 to 10 may be implemented as software, such as one or more application programs executable within the computer system 100. The instructions may be formed as one or more code modules, or computer program code means, each for performing one or more particular tasks. The software may also be divided into three separate parts, in which a first part and the corresponding code modules perform the data (entity) conversion 230, the second part and the corresponding code modules perform the assignment of GUID to the resultant entities as shown in FIGS. 6 to 10 and a third part and the corresponding code modules manage a user interface or the inter-device interface used for such tasks as receiving user commands, displaying processing outcome or receiving/outputting source/resultant entities or information about them if the system is configured such that relevant processing and relevant database are distributed over a network. The software may be stored in a medium, for example a computer readable medium including storage devices. The software is loaded into the computer system 100 from the computer readable medium, and then executed by the computer system 100. A computer readable medium having such software or computer program recorded on it is a computer program product.

As seen in FIG. 1, the computer system 100 is formed by a computer module 101 (GUID assignment system), input devices such as a keyboard 102 and a mouse pointer device 103, and output device may be a display device 114. The computer system 100 for data (entity) conversion may be constructed such that the database 201 storing the source entity and the database 202 storing resultant entity of the data (entity) conversion are separate and are each accessible via a network 120/122 from the computer module 101 for performing the GUID assignment for the resultant entity of the following embodiments, or it may be that one or both of the databases 201 and 202 are stored in the computer module 101 for performing the GUID assignment. Similarly, a computer device for performing the entity conversion may be accessible via a network 120/122 from the computer module 101 for performing the GUID assignment, or the entity conversion and the GUID assignment may be performed by the same computer module 101. For the ease of understanding, the following embodiments are described using a configuration where the entity conversion and GUID assignment are performed by the same computer module 101 and both the source entity database 201 and the resultant entity database 202 are stored in the computer module 101. In this configuration, the computer module 101 is still preferably connected to other computer systems via a network as data conversion is a means usually utilized when the data needs to be used by multiple computer systems often communicating with each other over a network.

An external Modulator-Demodulator (Modem) transceiver device 116 may be coupled to the computer module 101 for communicating to and from a communications network 120 via a connection 121. The network 120 may be a wide-area network (WAN), such as the Internet or a private WAN.

The computer module 101 typically includes at least one processor unit 105, and a memory unit 106 for example formed from semiconductor random access memory (RAM) and read only memory (ROM). Here, the processor unit 105 is an example of a processing means which can also be realized with other forms of configuration performing similar functionality. The module 101 also includes an number of input/output (I/O) interfaces including a video interface 107 that couples to the video display 114, an I/O interface 113 for such devices like the keyboard 102 and mouse 103, and an interface 108 for the external modem 116. In some implementations, the modem 116 may be incorporated within the computer module 101, for example within the interface 108. The computer module 101 may also have a local network interface 111 which, via a connection 123, permits coupling of the computer system 100 to a local computer network 122, known as a Local Area Network (LAN). As also illustrated, the local network 122 may also couple to the wide network 120 via a connection 124, which would typically include a so-called “firewall” device or similar functionality. The interface 111 may be formed by an Ethernet™ circuit card, a wireless Bluetooth™, an IEEE 802.11 wireless arrangement or a combination of thereof.

Storage devices 109 are provided and typically include a hard disk drive (HDD) 110. It should be apparent to a person skilled in the art that other devices such as a floppy disk drive, an optical disk drive and a magnetic tape drive (not illustrated) may also be used. The components 105 to 113 of the computer module 101 typically communicate via an interconnected bus 104 and in a manner which results in a conventional mode of operation of the computer system 100.

Typically, the application programs discussed above are resident on the storage device 109 and read and controlled in execution by the processor 105. Storage of intermediate product from the execution of such programs may be accomplished using the semiconductor memory 106, possibly in concert with the storage device 109. In some instances, the application programs may be supplied to the user encoded on one or more CD-ROM or other forms of computer readable media and read via the corresponding drive, or alternatively may be read by the user from the networks 120 or 122.

The third part of the application programs and the corresponding code modules mentioned above may be executed to implement one or more graphical user interfaces (GUIs) to be rendered or otherwise represented upon the display 114 or to implement other modes of input/output or storage control. Through manipulation of the keyboard 102 and the mouse 103, a user of the computer system 100 and the application may manipulate the interface to provide controlling commands and/or input to the applications associated with the GUI(s).

Overview of Entity Conversion and GUID Assignment

Processing of entity conversion and GUID assignment will be described in overview with reference to FIGS. 2 and 5.

FIG. 2 shows greater detail for the computer module 101, a GUID assignment system, of FIG. 1 where the computer module 101 is configured to perform both the entity conversion and the GUID assignment. For simplicity, FIG. 2 shows only the hardware modules which have functions pertaining to an embodiment of the present invention.

A source entity database 201, that records the source entities for the entity conversion and information about the source entities used for GUID assignment, is stored in the storage device 109. A resultant entity database 202 for recording the resultant entities generated as a result of the entity conversion and the GUID output from the GUID assignment module 204 corresponding to each resultant entity also is stored in the storage device 109. An entity conversion program module 203 and a GUID assignment program module 204 are stored in the storage device 109. Information about the entity conversion program and processing for all conversions is common or specific to respective source/resultant entities are also stored in the storage device 109.

FIG. 5 shows a flowchart of the entity conversion program module 203 and the GUID assignment program module 204. In step 501, the source entity for conversion is read out from the source entity database 201 by the processor 105. In step 502, the processor 105 converts the source entity according to the conversion mapping to output a resultant entity to be stored in the resultant entity database 202. Here, the conversion mapping used in step 502 to generate the resultant entity may also be stored in the resultant entity database 202 in correspondence to the resultant entity. If the source entity is a part of a sequence of source entities and the sequence as a whole is to be converted, the context information about the sequence may also be stored in the resultant entity database 202.

Information used for GUID assignment of a resultant entity in step 505 is collected in steps 503 and 504. In step 503, the processor unit 105 obtains information about the source entity which was used to generate the resultant entity to be assigned GUID, and the origin of the source entity (e.g., address information about the device in which it was originally generated/stored) from the source entity database 201. In step 504, the processor unit 105 obtains information about the conversion performed for the resultant entity from the conversion information stored in connection with the entity conversion program module 203 or stored in the resultant entity database 202. The steps 503 and 504 for obtaining source/origin/conversion information may vary according to the algorithm employed in the following assignment step 505, and the processor unit 105 may only obtain the information necessary for the assignment step 505.

In step 505, a GUID is generated based on the information obtained in steps 503 and 504, and is assigned to the resultant entity to be stored in the resultant entity database 202. Step 505 will be described in more detail later.

In FIG. 5, the entity conversion and the GUID assignment are performed in series, with the information about the resultant entity stored into the resultant entity database 202 before the GUID assignment commences. However, the arrangement of the two processes may vary, e.g., the entity conversion program module may directly provide the GUID assignment program module with the details necessary for the GUID generation, or the GUID assignment may be performed as an inset of the entity conversion process 502. A suitable arrangement can be selected according to such consideration as processing resources, processing speed or system configuration.

GUID Assignment

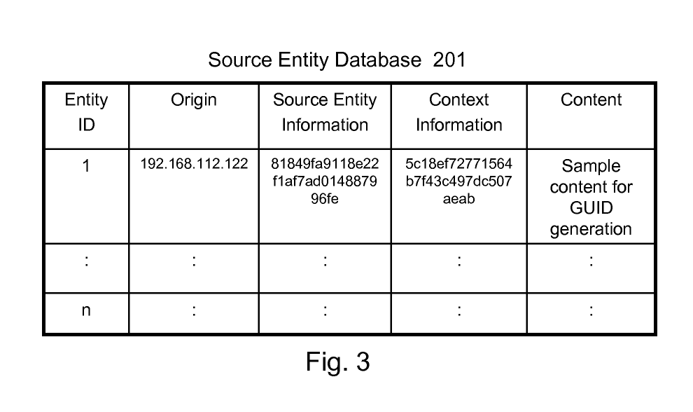

Next, the details of GUID assignment 505 will be described referring to FIGS. 3-10.

Referring firstly to FIG. 5, using the information retrieved by steps 503 and 504, it is possible to form four kinds of unique IDs in a GUID assignment 505, namely, 1) origin unique ID, 2) source entity unique ID, 3) mapping unique ID, and 4) source entity context unique ID. With various combinations of those four IDs, the following three categories of GUID can be obtained for the resultant entity: a) simple data conversion GUID, b) mapping sensitive data conversion GUID, and c) context sensitive data conversion GUID.

a) Simple data conversion GUID: This process generates a GUID that ensures that, every time the same record is converted by applications doing the conversion, the same GUID will be generated. For simple data conversion GUID, 1) origin unique ID and 2) source entity unique ID are used.

b) Mapping sensitive data conversion GUID: This process uses the simple data conversion GUID and additionally has a capability where the GUID generated will be unique for a particular mapping (conversion algorithm) being followed. For mapping sensitive data conversion GUID, 1) origin unique ID, 2) source entity unique ID and 3) mapping unique ID are used.

c) Context sensitive data conversion GUID: This process uses the simple data conversion GUID and additionally has a capability where the GUID generated will be unique for a particular context (sequence of occurrence in the source). If the context, i.e. sequence of occurrence, or the content before the entity in question is changed, then the GUID changes also. For context sensitive data conversion GUID, 1) origin unique ID, 2) source entity unique ID, 3) mapping unique ID and 4) source entity context unique ID are used.

The 2nd and 3rd procedures may also be used together to give both of these capabilities to the GUID generated.

The source entity database 201 and the resultant entity database 202 store information that is used for GUID assignment.

FIG. 3 shows a schematic structure of the source entity database 201. In correspondence with each source entity, there are stored information about the entity ID for the purpose of indexing within the source entity database 201, source entity information for use in generating source entity unique IDs, context information for use in generating source entity context unique IDs, and the actual content of the source entity.

The origin information may include information indicating the address/location of the apparatus where the source entity was originally generate or stored. Information inherent to the source entity, e.g., the GUID of the source entity, is stored as source entity information. If the source entity occurs in multiple contexts, there may be multiple entries for the context information index, or the context information may be stored in connection with each sequence, or it can also be stored in connection with the resultant entity in the resultant entity database 202. The content of the source entity may or may not be stored together with the other information. This database may simply have a pointer to the address of another database especially storing the entities themselves.

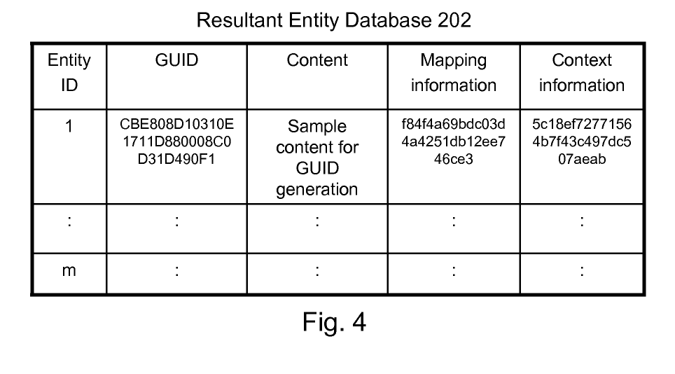

FIG. 4 shows a schematic structure of the resultant entity database 202. In correspondence with each resultant entity, there are stored information about the entity ID for the purpose of indexing within the resultant entity database 202, the content of the resultant entity, mapping information about the mapping used in the entity conversion process. The context information may also be stored in the resultant entity database 202, indicating the context the source entity was found in when it was converted into that resultant entity. A field for the GUID to be assigned to the resultant entity is prepared. The entries for the content, mapping information and the context information can be stored at the time when the conversion is performed to generate the resultant entity. These items of information can be read out by the processor 105 to perform GUID assignment.

Next, algorithms for obtaining 1) origin unique ID, 2) source entity unique ID, 3) mapping unique ID and 4) source entity context unique ID will be described in detail. The probability of uniqueness depends on the probability of uniqueness of its components. Each of the components has to be derived from the source entity or information concerning it, or the information about the conversion performed on it.

1) Origin Unique ID

This ID is required to uniquely identify the origin (the original location) of the source entity, e.g., information/record. Ideally, all the information pertaining to this should come from the source entity itself. But since this may not be always available, this information may be obtained from the system which the source entity is retrieved from. This could be generated by using a GUID algorithm and tagging the source entity with this information, or simply by hashing the information available from the source so that a unique identifier is obtained which would not change as long as the input parameters corresponding to the source entity do not change.

This ensures that every time a particular origin of a source entity is connected to, it is possible to identify the source, that is, the GUID will always be the same every time. Also, if all this information necessary for this ID can be retrieved from the source entity itself, there is an additional advantage that provides the freedom of moving the file including the source entity and still being able to identify it with the same ID that would have been used for the entity when the entity was in its original location. While this information is not mandatory in all embodiments, if this information is provided, then the probability of uniquely identifying the source entity increases.

Referring to FIG. 6, a flowchart for generating the origin unique ID is shown, and executes as follows.

In step 601, a unique identification for the system/machine/location where the source entity originated (in protocols such as the IEEE 802 Media Access Control address/URL/IP address) is retrieved from the source entity database 201. The information in the source entity database may originally be obtained from the source entity itself if available; else it is retrieved from the system of origin. In step 602, information about the file/database of origin of the source entity such as the file/database name, creation details, location in the file system is retrieved from the source entity database 201. In step 603, information about the application that generated the source entity is retrieved from the source entity database 201. The information in the source entity database may originally be obtained from the source entity itself if available; else it is retrieved from the system of origin. Steps 601-603 may be performed independently without the need to perform the other steps, or can be performed in combination of any two, or all three.

In step 604, a hash of the information retrieved in step 601-603 is calculated. Known methods such as MD5 or SHA-1 can be used to calculate the hash. If more than two of the steps 601-603 are performed, the results of the performed steps are concatenated and then used to calculate the hash value.

Although an example of “database” is used here, any other form of storing or inputting the entity and its associated attribute is also possible as long as the processing means can make the association between them for the purpose of GUID generation of this invention.

2) Source Entity Unique ID

If the source entity has any identifier that uniquely identifies it within the context, then that unique identifier can be used for the source entity unique ID. Otherwise, the source entity content itself can be used as the source entity unique ID, with details on the process and thread generating the message if available.

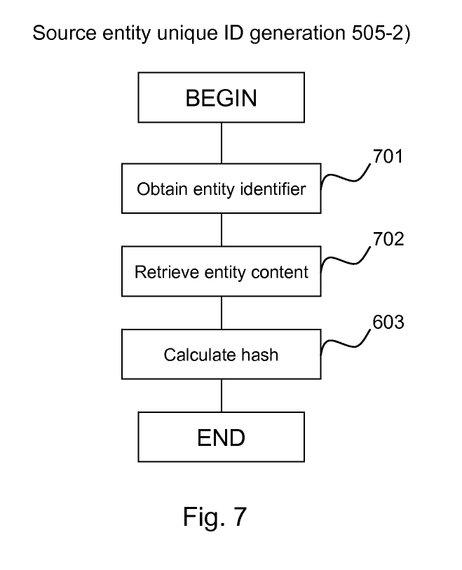

FIG. 7 shows a flowchart for generating the source entity unique ID. In step 701, the source entity identifier is obtained from the source entity database 201 if available. In step 702, the source entity's content itself is retrieved from the source entity database 201, with information on the process or/and thread to improve uniqueness when available. The steps 701 and 702 are alternatives, and either one of them can be employed, or they can both be employed in combination. In step 703, a hash of the information retrieved in step 701 and 702 is calculated. If both steps 701 and 702 are performed, the results are concatenated and then used to calculate the hash value.

3) Mapping Unique ID

The use of the mapping unique ID has the advantage of enabling the correlation to a conversion, so that one converted resultant entity can be distinguished from another resultant entity that was generated using a different conversion mapping. This can be created by applying MD5, SHA-1-based, or any other hashing to the conversion rules if available, or by simply using a GUID to tag the conversion algorithm that was used for the resultant entity.

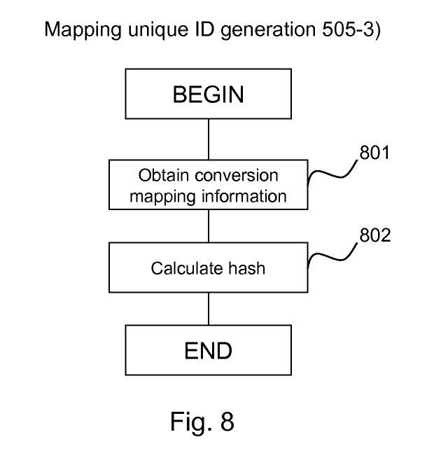

FIG. 8 shows a flowchart for generating the mapping unique ID. In step 801, conversion mapping information is obtained from the conversion information in the resultant entity database 202, or information stored in connection with the entity conversion program module. In step 802, the hash of the information obtained in step 801 is calculated. It would be the responsibility of the mapping provider to ensure the uniqueness of the mapping in the mapping unique ID. Information other than the above can also be used as long as it ensures uniqueness for that particular set of rules used in the entity conversion process.

4) Source Entity Context Unique ID

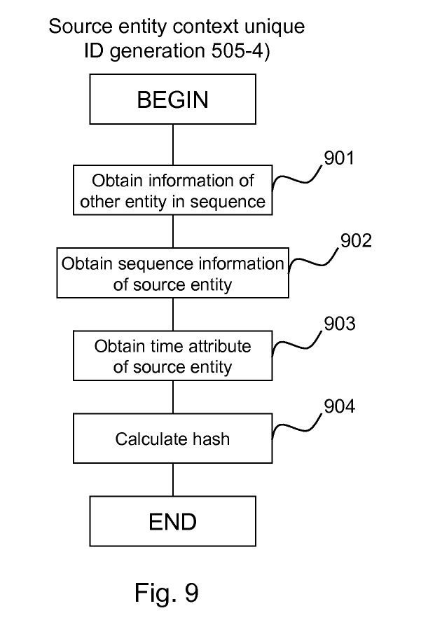

A source entity context unique ID is specifically required in cases where the order of occurrence of the entities and the scenario it occurs in is important. FIG. 9 shows a flowchart for generating the source entity context unique ID.

In step 901, the GUID of the previous resultant entity, coming from a source entity in the same sequence as the source entity converted into the resultant entity in question, is obtained from the resultant entity database 202. If no previous resultant entity from the same sequence is available, then a default GUID can be used. This approach will ensure that the order and the content of the original sequence from which the source entity was taken is considered while generating this GUID, and if the order or the content of the original sequence changes then this resultant entity of the new conversion will have a new, different GUID. The previous source entity may also be used to produce the same effect.

In step 903, sequence information, such as the sequence number of the entity being processed indicating the placement of the entity within the sequence, with the time of the record if available, is obtained from the context information of either the source entity database 201 or the resultant entity database 202. This concentrates on the order of occurrence and a factor of time, with the content of the previous entity not being of the utmost importance.

In step 903, the time of the entity (e.g. the time the source entity was originally generated) if available is obtained. This approach uses the time attribute of the entity and does not need information about its context.

Steps 901-903 provide different levels of context uniqueness for a GUID of the resultant entity. Steps 901-903 can be used in combination, or independently. In step 904, the hash of the information obtained in steps 901-903 is calculated. If two or more items of information are obtained, then those items of information are concatenated before calculating the hash.

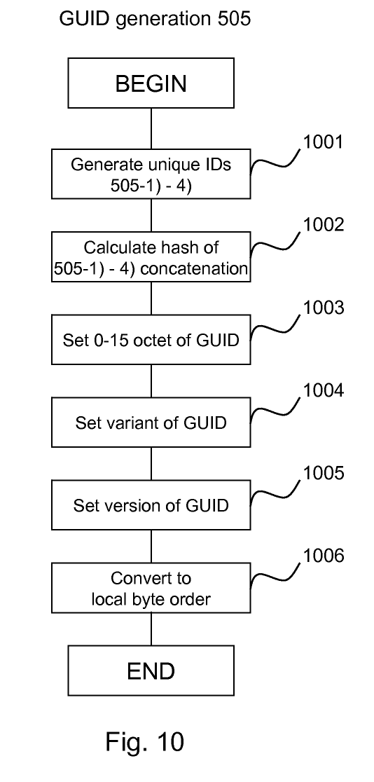

Next, the algorithm for generating the data conversion GUID is described referring to a flowchart shown in FIG. 10.

In step 1001, unique IDs are prepared according to algorithms described using FIGS. 6 to 9. As described earlier, different combination of 1) origin unique ID, 2) source entity unique ID, 3) mapping unique ID, and 4) source entity context unique ID are prepared depending on which of the a) simple data conversion GUID, b) mapping sensitive data conversion GUID, and c) context sensitive data conversion GUID is used.

In step 1002, the hash of the concatenation of IDs obtained in step 1001 is calculated using a hash functions by putting all the GUIDs in the network byte order and the text in a canonical sequence of octets.

In step 1003, the 0-15 octet of the GUID with the 0-15 octet of the generated hash is set.

In step 1004, the variant is set in accordance with the IEEE specification regarding a standard for generating GUID's as follows:
(1) The XOR of bits 67, 68, and 69 with bits 70, 71, 72 is calculated and the results are stored in bits 67, 68, and 69 respectively.
(2) The bits 70, 71, 72 are set to high (or any other value according to the variant specified).

In step 1005, the GUID version is set as per the IEEE specification as follows:
(1) The XOR of bits 49, 50, 51, and 52 with bits 53, 54, 55, 56 is calculated and the result is stored in the bits 49, 50, 51, 52 respectively.
(2) The bits 53, 54, 55, 56 are set to all high (or any other value as per the version specified).

In step 1006, the resulting GUID is converted to local byte order and tagged to the resultant entity.

The generated GUID will provide an identification for a converted resultant entity with a very high probability of being unique.

The result of the GUID assignment can be stored in the resultant entity database 202, or can be transmitted to another computer system via the network 120/122 from the communication interface 108/111. If the computer module 101 has the body of the resultant entity, then the resultant entity can be sent to the network 120/122 with the generate GUID tagged onto it, and if not, the generated GUID can be returned to the computer system in possession of the resultant entity which requested the GUID assignment.

The above embodiments are described using a configuration as shown in FIG. 2, where the entity conversion is performed in the same computer module 101 as the GUID assignment and all the relevant information is stored in the computer module 101. The present invention also can be applied to systems with other configurations. For example, the entity conversion can be performed by a separate conversion server accessible via a network, in which case the source entity database and/or the resultant entity database may be stored in a storage device accessible via the network or is created and stored in the computer module 101 using information transmitted from an external information source.

The methods described in the embodiments generate a GUID which enables correlation between the source entity and the origin of the source entity, conversion mapping, or the context in which the source entity was found. The methods described herein will be useful in scenarios such as log conversions (as described), data migration, and managing unstructured information.

We claim:

1. A method of providing unique identification for a resultant entity generated by converting a source entity, said method comprising:
retrieving origin unique identification information;
retrieving source entity unique identification information;
generating unique identification for the resultant entity from said retrieved information.

2. The method of claim 1, wherein said retrieved information further comprises conversion mapping unique identification information.

3. The method of claim 1, wherein said retrieved information further comprises source entity context unique information.

4. The method of claim 2, further comprising converting said source entity to generate said resultant entity.

5. The method of claim 1 wherein said conversion of said source entity to said resultant entity is performed by a data conversion server accessible via a network, further comprising receiving at least said origin unique identification information and said source entity unique identification information from said data conversion server via said network.

6. The method of claim 1, further comprising calculating hash information from said retrieved source information to generate said unique identification.

7. The method of claim 1, further comprising transmitting said resultant entity with said associated hash information to another computer system via a network from a communication interface.

8. A Globally Unique ID (GUID) assignment system for assigning a Globally Unique ID (GUID) to a resultant entity generated by converting a source entity, said system comprising:
a storage device for storing at least information about said source entity corresponding to said resultant entity and an origin of said source entity; and
a processing means;
wherein said processing means is for generating an origin unique ID using said information about said origin of said source entity and a source entity unique ID using said information about said source entity, and generating a GUID for the resultant entity from said origin unique ID and said entity unique ID.

9. The system of claim 8, wherein said storage device is further for storing information about conversion mapping used to generate said resultant entity from said source entity, and said processing means is further for generating a mapping unique ID using said information about said conversion mapping, and generating said GUID for the resultant entity from said origin unique ID, said entity unique ID and said mapping unique ID.

10. The system of claim 8, wherein said storage device is further for storing information about a context in which said source entity was in for said conversion, and said processing means is further for generating a source entity context unique ID using said information about said context, and generating said GUID for the resultant entity from said origin unique ID, said entity unique ID and said source entity context unique ID.

11. The system of claim 9, wherein said processing means is further for converting said source entity to generate said resultant entity and storing said information about conversion mapping used in said conversion in correspondence with said resultant entity in said storage device.

12. The system of claim 8 wherein said conversion of said source entity to said resultant is performed by a data conversion server accessible by said GUID assignment system via a network, said storage device is further for receiving at least said information about said source entity and said origin of said source entity from said data conversion server via said network to be stored.

13. The system of claim 8, further comprising a communication interface for transmitting said resultant entity with said generated GUID tagged onto said resultant entity to another computer system via a network.

14. The system of claim 8, wherein said processing means is further for calculating hash information from at least said origin unique ID and said entity unique ID to generate said GUID for the resultant entity.

15. A computer program product having a computer readable medium having a computer program recorded therein for method of assigning a Globally Unique ID (GUID) to a resultant entity generated by converting a source entity, in a GUID assignment system having a processing means and a storage device, said computer program comprising:
computer program code means for inputting information about said source entity corresponding to said resultant entity and an origin of said source entity into said processing means from said storage device;
computer program code means for generating, at said processing means, an origin unique ID using said information about said origin of said source entity, and a source entity unique ID using said information about said source entity;
computer program code means for generating a GUID for said resultant entity from said origin unique ID and said entity unique ID.

16. The computer program product of claim 15, wherein said computer program further comprises:
computer program code means for inputting information about conversion mapping used to generate said resultant entity from said source entity;
computer program code means for generating a mapping unique ID using said information about said conversion mapping; and
computer program code means for generating said GUID for the resultant entity from said origin unique ID, said entity unique ID and said mapping unique ID.

17. The computer program product of claim 15, wherein said computer program further comprises:
computer program code means for inputting information about a context in which said source entity was in for said conversion;
computer program code means for generating a source entity context unique ID using said information about said context; and
computer program code means for generating said GUID for the resultant entity from said origin unique ID, said entity unique ID and said source entity context unique ID.

18. The computer program of claim 16, wherein said computer program further comprises:
computer program code means for converting, by said processing means, said source entity to generate said resultant entity; and
computer program code means for storing said information about conversion mapping used in said conversion in correspondence with said resultant entity into said storage device.

19. The computer program product of claim 15 wherein said conversion of said source entity to said resultant is performed by a data conversion server accessible by said GUID assignment system via a network, wherein said computer program further comprises computer program code means for receiving at least said information about said source entity and said origin of said source entity from said data conversion server via said network to store in said storage device.

20. The computer program product of claim 15, wherein said computer program further comprises computer program code means for transmitting said resultant entity with said generated GUID tagged onto said resultant entity to another computer system via a network from a communication interface.

21. The computer program product of claim 15, further comprising:
computer program code means for calculating hash information from at least said origin unique ID and said entity unique ID to generate said GUID for the resultant entity.
